(19) United States
(12) Patent Application Publication
(10) Pub. No.: US 2014/0202721 A1
(43) Pub. Date: Jul. 24, 2014

(54) FIRE RETARDANT AND SMOKE-GUARD DOOR BARRIER

(71) Applicant: Alan Shaw, Lockport, NY (US)

(72) Inventor: Alan Shaw, Lockport, NY (US)

(73) Assignee: BUTTERFLY SAFETY PRODUCTS LLC, Buffalo, NY (US)

(21) Appl. No.: 14/159,039

(22) Filed: Jan. 20, 2014

Related U.S. Application Data
(60) Provisional application No. 61/754,714, filed on Jan. 21, 2013.

(51) Int. Cl. A62C 2/06

(52) U.S. Cl. CPC A62C 2/06
USPC 169/48

(57) ABSTRACT

A smoke-barrier device for securely sealing the spaces beneath and around a door and a fire and smoke retardant door cloth panel will gain two or more hours for a person(s) trapped by a fire in a closed room, even one that has a residential style wood door that is known to burn in about 20 minutes. The combined use of the tested and rated smoke-guard device and the tested and rated fire and smoke retardant panel will prevent fire, smoke, and lethal gases from entering the room through a doorway even after the wooden door burns through.

### CROSS-REFERENCE TO RELATED APPLICATIONS

This Non-Provisional application for patent claims the benefit of Provisional Application No. 61/754,714 filed Jan. 21, 2013.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

The present invention relates generally to fire protection means and more particularly to tested and rated barriers that block smoke, lethal gases, and fire from entering a room through a doorway for up to two hours, even if the door itself burns away.

The background information discussed below is presented to better illustrate the novelty and usefulness of the present invention. This background information is not admitted prior art.

As a safeguard against the threats posed by a fire there should be two means of exit from all rooms. This, however, is often not the case especially in high rise buildings. When a fire alarm sounds and there is only one exit from a closed room, it is advised that before opening the door to exit the building, the temperature of the door should first be determined. If, from top to bottom, the door feels cool and if no smoke is leaking into the room from openings about the door, then the door may be cautiously opened to ascertain if there is a safe path to exit the building.

If the door feels hot or even warm to the touch, and/or smoke is entering the room though gaps in the doorway, fire is likely too close to safely attempt opening the door. In this case, as quickly as possible, one should seal all of the openings around the door to prevent smoke and fire from coming into the room, especially from the space between the bottom of the door and the floor. Smoke and poisonous gases are the number one killer in a fire, so preventing smoke from entering the room is of utmost importance. Most doors, especially doors in hotels and office buildings, have such mandated gaps between the bottom of the door and the floor to prevent the floor, or more likely the carpet on the floor, from preventing the opening or closing of the door. It is often suggested to use a wet towel to plug the open space at the bottom of the door; lacking a wet towel use anything that is available. The narrow openings between the sides and top of the door and the door jamb should also be sealed. It is best to do this by using the most robust tape available.

Hotel doors and the doors of other commercial and high-rise buildings are likely to be fire-rated. Solid wood doors are usually fire-rated to 20 minutes. Sadly, the most common residential building doors are most likely not fire-rated. In fact, a standard hollow or six-panel door will burn-out in 3-5 minutes. In such cases, preventing smoke from entering a room will provide only a very short-term benefit to those caught in a burning building in a room closed behind a standard hollow or six-panel door.

In the event of a fire if there is a window that provides a safe exit it should be used to quickly exit the building. However, the windows in floors above two stories do not prevent a viable option, unless there is a fire-escape within reach. Although aerial ladders on fire trucks are about 100 feet in length, it is not likely for these ladders to reach to that height even when extended because of the distance from the building the fire truck must be parked. If fire-fighters are unable to reach a room from the outside, persons in the room will have to stay in the room and try to keep the smoke and fire from entering the room. A telephone or a cell phone should be used to alert others to the situation. Although tempting, there is real danger in breaking a window to call for help as an open window will provide a draft that may likely encourage the fire and smoke to enter the room with opened window.

### SUMMARY

In the situations where the door is not a fire-rated door, as mentioned above, smoke-guards alone can offer only a short period of protection from a fire. Thus, the present Inventor formulated an inventive concept to protect persons who find themselves trapped in a closed-door room during a fire. The concept includes a device that will stop fire from entering a room even if the non-fire-rated door completely burns when used in combination with a smoke-guard device.

Most doors, whether fire-rated or not, are mandated to have a gap of about an inch between the bottom of the door and the floor. This gap presents a perfect pathway for smoke, fire, and lethal gases to enter a room even when the door is closed. The advice of stuffing a “wet towel” into the gap between the bottom of the door and the floor in the event of a fire is not a realistic solution, for many reasons. Many rooms are not supplied with either towels or water and even a wet towel will dry and burn in a short period of time, providing only minutes of safety.

The inventive concept and its principles as taught herein provide for a smoke-guard device and a fire-stop cloth door panel that will stop fire, smoke, and lethal gases from coming through the door opening even if the door itself completely burns. The smoke-guard device is constructed of compressible/expandable material covered by fire-rated cloth to be inserted into a gap between the bottom of the door and the floor to prevent any smoke from traversing the gap. The smoke-guard is easy to use, fills the gap between the bottom of the door and the floor entirely, will not burn, and is impervious to smoke and gas. Smoke-guards are made by wrapping and fixing a first end of a length of high temperature material that is smoke, gas, and water impermeable about a piece of a material that easily compresses and expands to its original state, such as memory foam. Recommended, but not required for the inventive concept to be fulfilled, a second end of the length of material may be wrapped about and fixed to a magnet, ideally, but not necessarily, the width of the door, assuming the door with which it will be used is a metal door. To use the smoke-guard, the memory foam end is easily positioned within the space between the bottom of the door and, if the door is a metal door and there is a magnet end of the smoke-guard, the magnet end of the smoke-guard is positioned on the interior of the door providing additional security that the smoke-guard will stay in place. If the door to be protected is a wooden door, there is a smoke-guard package available that provides an additional strip of magnetic metal that is to be, at an earlier time, affixed to the inside of the wooden door near the bottom of the door so that once the smoke-guard is in place, there is a magnetic strip to accept the magnetic end of the smoke-guard. Alternatively or additionally, the device is provided with a strip of fire-rated tape to adhere the second end of the smoke-guard to the door to further enhance the life and effectiveness of the device. Additionally provided in the smoke-guard package are strips of fire-rated tape to be placed over the gaps on the sides and top of the door to complete the smoke-guard protection. The smoke-guard device and its accessories are all fire-rated and will stop fire, heat, smoke, and gas from entering the room for two or more hours as long as the door does not burn. Sadly, many, if not most, of today's doors for private residences are not fire-rated and will burn within minutes. To provide a protection against smoke and fire that will last hour even when used with a non-fire-rated door, the present inventive principles include a fire-rated fire-resistant cloth door panel to be positioned over a door and used in conjunction with the smoke-guard unit.

The fire-retardant and smoke impervious door panel comprises a fire-rated fire-resistant cloth panel the size of a standard door with a magnetic sensitive strip attached to the top end of the panel and a magnetic sensitive strip attached to the bottom edge of the panel, another part of the panel package is a magnetic metallic installation bar that is to be installed on the door when the device is first purchased. In the event of a fire, first the smoke-guard, as described above, is taken out of its container and positioned in the gap between the bottom of the door and the floor. Once the smoke-guard is in position, and the room is secured against the entry of smoke, poisonous gas, and fire through the gap between the bottom of the door and the floor, the next step is to position the accessory stripes of tape over the openings about the sides and top of the door. Once the room is, thus, secured from the deadly smoke and gas from which kill most people caught in a fire, the panel is to be installed. The magnetic sensitive strip at the top of the panel is lifted over the magnetic installation bar that was earlier installed on the door. The panel is unrolled the length of the door and the magnetized strip at the bottom edge of the panel is magnetically adhered to the magnetic strip that is part of the smoke-guard device. Magnetism is not altered by the presence of the heat and temperature of a house fire and provides for a strong attachment of both the smoke-guard and the fire-stopping panel. Additional fire-rated tape is then positioned about the sides of the panel. This attachment of the panel to the door frame is strong enough to prevent fire and smoke from entering through the doorway for up to two hours even if the door is completely burnt away. The fire-rated panel and the smoke-guard are stored easily accessible in an aesthetically pleasing, easy to access package that is stored adjacent to the door.

Additionally, the set of inventive principles not only provides for various styles and sizes of the smoke-guard device, the door-panel and their accessories so that needs for all doors may be met, it also provides for additional aids to give help to those caught in a room during a fire. One aid comprises a set of self-adhering intumescent material strips that are to be placed over side and top of door openings to further secure a closed room from smoke. Intumescent material automatically expands when heated providing another layer of protection. Also provided is reflective tape to be adhered to a window to give notice to emergency rescue personnel that there is someone in that room that needs to be rescued, and a light means, such as a flashlight, and/or a glow-light that lasts 12 hours without a battery or other power. IBC (International Building Code) 2006 mandates that the smoke-guards of the present invention be tested in accordance with UL1784 for smoke and draft-control doors having an artificial bottom seal installed across the full width of the bottom of the door assembly. The air leakage rate of the door assembly shall not exceed 3.0 cubic feet per minute per square foot of door opening at 0.10 inch (24.9 Pa) of water for both the ambient temperature test and the elevated temperature exposure test. Additionally, all fire doors with shutter assemblies shall be constructed of any material or assembly of component materials that conforms to the test requirements of Section 715.4.1, 715.4.2 or 715.4.3 and the fire protection rating indicated in Table 715.4. Fire door assemblies and shutters shall be installed in accordance with the provisions of this section and NFPA 80. Fire-retardant cloth panels, such as the door panel of the present invention, must be and has been rated by UL test 1 11 2013 #UL 1715 (open fire in front center door) on Jan. 16, 2013 by Guardian Laboratories, 474 Hinman Avenue Buffalo, N.Y. 14216. The smoke-guard, door panel, and all fire-protective accessories have been so tested.

To be described in detail below, then, is a fire-stopping opening-cover, comprising a fire-rated cloth panel sized and shaped to cover a specifically sized opening with borders about the opening using fire-rated tape to secured the panel to the borders of the opening to prevent fire, smoke, and lethal gases from passing through the opening for up to two hours. The panel and opening each having at least one border having magnetic properties with the magnetic panel border to be secured to the magnetic opening border in the case where the opening is a doorway in a wall fitted with a metal doorframe and a metal door having magnetic properties. Where the opening is a doorway in a wall fitted with a wooden doorframe and a wooden door, there is included a magnetic metal bracket with for securing over a top-piece of a wooden, or a metal door frame, with the metal bracket positioned so as to provide a magnetic border for the doorway opening. Where the door and or the doorframe have magnetic properties, a first end of the panel is provided with magnetic properties. A piece of magnetic metal may be enclosed within the first end of the panel to provide magnetic properties to the panel. The fire-stopping opening-cover may also further including a magnetic strip positioned between the top-piece of the door frame and the wall so as to be a source of extra strong magnetic properties. The fire-stopping opening-cover, when used with a smoke-guard or with a magnetic metal door and door-frame, will be provided with its second end having magnetic properties. If desired, a piece of magnetic metal enclosed within the second end of the panel will be the source of the magnetic properties. The fire-stopping opening-cover ideally will be used with a smoke-guard device, comprising compressible/expandable material covered by a first end of fire-rated cloth sized for insertion into a gap between the bottom of a closed door and a floor to prevent any smoke from traversing the gap before securing the panel to the border openings. The fire-stopping opening-cover panel may have its second end of fire-rated cloth magnetized to secure the smoke-guard device to the magnetic portion of the door. A metal bar secured in the second end of the fire-rated cloth may be the source of the magnetization. A piece of magnetic metal secured to the door, when the door is a wooden door, provides a magnetic portion to the door. In summary, there is a smoke, lethal gas, and fire stopping combination for a doorway fitted with a magnetic metal door and magnetic metal door frame, comprising: a smoke-guard device comprising: a fire-resistant cloth having a first end secured about a compressible and expandable material that is sized to be inserted into a space between the bottom of a door and a floor, and a second end magnetized to be secured to the door, along with fire-resistant intumescent-coated tape sized to cover gaps between a doorframe in a wall and the sides and top of the door, so that once the first and second end of the device are inserted and secured, respectively, the device will prevent fire, heat, smoke, and gas from passing through the doorway for two or more hours as long as the door does not burn. This is ideally used with a fire-rated cloth panel sized and shaped to cover the door, and having a magnetized first end and a magnetized second end, where the magnetized first end is to be magnetically secured to a top-piece of the doorframe, and the magnetized second end to be magnetically secured to the second end of the magnetized cloth of the smoke-guard device once the smoke-guard device is inserted and secured, and fire-resistant intumescent tape sized so as to seal the sides of the panel to the wall so as to secure the doorway against the passage of smoke, lethal gas, and fire for up to two hours even if the door burns. And lastly, there is a smoke, lethal gas, and fire stopping combination for a doorway fitted with a wooden door, comprising a smoke-guard device comprising a fire-resistant cloth having a first end secured about a compressible/expandable material sized to be inserted into a space between the bottom of a door and a floor, and a second magnetic end to be secured to a magnetized portion of the door, and fire-resistant intumescent-coated tape sized to be cover gaps between a doorframe in a wall and the sides and top of the door so as to prevent fire, heat, smoke, and gas from passing through the doorway for two or more hours as long as the door does not burn, and, ideally to be used with, a fire-rated cloth panel sized and shaped to shield the door having a magnetized top-piece of the doorframe, with the panel having a first and a second end magnetized, where the first end is to be magnetically secured to the magnetized top-piece, and the second end to be magnetically secured to the second magnetic end of the smoke-guard once the smoke-guard is inserted into the space between the bottom of the door and the floor, and fire-resistant intumescent tape sized so as to seal the sides of the panel to the wall so as to secure the doorway against the passage of smoke, lethal gas, and fire through the doorway for up to two hours even if the door burns. The smoke, lethal gas, and fire stopping combination further includes a strip of fire-rated tape so as to further adhere the second end of the smoke-guard to the door, and a magnetic metal bracket for securing over the top section of the door frame, and if desired, a magnetic strip may be positioned between the metal bracket and the wall for additional magnetic strength and a magnetic strip sized to be affixed to the door for securing the second end of the smoke-guard to the door.

### BRIEF DESCRIPTION OF THE DRAWINGS

In order that these and other objects, features, and advantages of the present invention may be more fully comprehended, the invention will now be described, by way of example, with reference to the accompanying drawings, wherein like reference characters indicate like parts throughout the several figures, and in which:

FIG. 1 is a plan view illustrating the basic construction of a smoke-guard embodiment of the present invention.

FIG. 2 is a side view of the present invention as illustrated in FIG. 1.

FIG. 3 is a perspective diagrammatic sketch illustrating one way to make a smoke-guard device according to the principles of the present invention.

FIG. 3a is a perspective diagrammatic sketch illustrating a smoke-guard device ready for use.

FIG. 3b is a perspective diagrammatic sketch illustrating a smoke-guard device in use according to the principles of the present invention.

FIG. 4 is an elevation view of a wooden door with a magnetic strip attached.

FIG. 5 is a diagrammatic view of an embodiment of the present invention that is installed within the body of the door.

FIG. 6 is a sketch of a wall with a door and window to show the use of some of the accessories according to the inventive concept.

FIG. 7 is a view illustrating a known residential door and its door frame.

FIG. 8 is a perspective diagrammatic sketch of one example of a metal sleeve fitting to be installed over the top-section of a door frame and a door frame top-section according to the present inventive concept.

FIG. 9a is a perspective diagrammatic sketch of another example of a metal fitting to be installed over the top-section of a door frame according to the principles of the present invention.

FIG. 9b is a perspective diagrammatic sketch illustrating the metal fitting, as illustrated in FIG. 9a, being installed over the top section of a door frame.

FIG. 10A is a perspective diagrammatic sketch of an exemplary embodiment of the present invention as it is being installed to cover the door.

FIG. 10B is an illustration of a pole to extend a person's reach.

### REFERENCE CHARACTERS AND PARTS TO WHICH THEY REFER

2 A fold line.
4 A sew line.
6 A fold line.
10 A smoke-guard device.
12 High temperature cloth.
14 Two sided-tape.
16 Magnetic material.
18 Compressible/re-expandable material, for example foam.
20 Intumescent.
30 Wooden door.
32 Magnetic strip.
34 Attachment means.
44 Known residential wooden door.
45 Top horizontal section of a door frame.
46a Right vertical section of a door frame.
46b Left vertical section of a door frame.
50 Fire and smoke retardant door panel.
52 Metal fitting for installation over top door frame—one example.
53a Attachment means aperture.
53b Attachment means to insert into aperture 53a.
54 Metal fitting for installation over top door frame—another example.
56 Magnet for use with any types of metal fitting for installation of top door frame.
57 Sew line.
59 Optional strip of intumescent tape.
60 Open space at bottom of door.
62 Pole with hook 64a.
64a Hook.
64b Eye hook receptor.
72 Tape.
74 Iridescent or fluorescent tape.
76 Flashlight.
80 Window.
82 Wall.
112 Top surface of present invention.
114 Releasing fixture.
116 Hollow door volume.
120 Dry wall.
122 Floor.
130 Magnetized top area of panel 30.
132 Magnetized bottom area of panel 30.
140 Fire resistant tape.

### DEFINITIONS

Attachment means or materials, as used herein, refers to tapes, double-sided tapes, glues, adhesives, staples, sewing means, pins, screw, nails, and magnets, including any other means, known or yet to be known, to fasten materials together.
Border, as used herein, refers to that part or parts that form the outer edge of something, such as a door-frame or a window-frame that both form the outer edge of the spaces, which may be referred to as the doorway or the window-opening, respectively.
Fire-retardant foam, as used herein, refers to any lightweight self-expanding materials, such as intumescent, that when compressed will re-expand and are formulated to contain flame-retardant additives or to be being inherently non-flammable and also may have the properties of low smoke density, low toxic gas emission, low heat release, enhanced chemical and solvent resistance, high levels of structural rigidity, chemical stability, UV-resistance, and will not absorb water.
High-temperature cloth, as used herein, refers to any tested and rated high-temperature fire-barrier material, also referred to as fire-resistant, such as a cloth or a blanket, for example, that is flexible, strong, protective, and fire-resistant, made of, but not limited to, continuous filaments, amorphous silica yarns, polymeric material, fiberglass reinforced polymeric material, high-temperature resistant woven textiles, metallized cloth including stainless steel and aluminum foil, and may also include impermeable material.
High-temperature thread, as used herein, refers to any thread that is fire-resistant or any thread that will not support combustion, such as a ceramic thread.
Impermeable membrane, as used herein, refers to a material that does not allow the passage of a fluid, such as water, other liquids, and/or gases, including smoke. The impermeable material disclosed herein includes a flexible, fluid-impermeable, sealing layer that is used for waterproofing by applying one or more layers of the membrane material onto a surface and/or object to be protected. Such impermeable blanket layers are made of a variety of materials, such as, but not limited to, silicone, fiberglass fabric coated with silicone rubber, coal tar, bitumen and synthetic polymers that are formed as sheet-like substances of desired sealing properties. Material and substance properties of impermeable membranes used herein meet the requirements of any particular structure, building, authority, climate, chemical and physical environment, required durability, cost effectiveness and the like and are fire-tested and rated to 1500° F.
Intumescent fire-retardant coatings, as used herein, refers to those materials having properties that cause them to expand (or intumesce) to several times their original size when activated by high temperatures to prevent the spread of flames and smoke to other parts of a building, in some cases delaying the spread of fire by as long as one hour. The intumescent material is available in many forms and may be, for example an intumescent layer, mat, strip, or paste, such as a caulking material. When exposed to heat over 300 degrees Fahrenheit (149 degrees Celsius), intumescents generate a thick layer of ash or foam, which conducts heat poorly, and burns slowly. The expansion of intumescent materials generally is to about 15-30 times their original thickness. Many intumescents contain chemically bound water, and are endothermic and when exposed to fire, intumescents release their bound water to help cool the surrounding areas.
Magnetic material, as used herein, refers to materials that are magnetized and create their own persistent magnetic field. Materials that can be magnetized, and, thus, are strongly attracted to a magnet, are called ferromagnetic and include iron, nickel, cobalt, alloys thereof, some alloys of rare earth metals, and some naturally occurring minerals such as lodestone.
Panel, as used herein, refers to a section of material that may be, but is not limited to, a section of fire-resistant cloth or a section of intumescent coated fire-resistant cloth.
Seaming, as used herein, refers to connecting one part to another part, for example where a cloth is folded and the two parts of the cloth that have been brought together by the folding are subsequently “seamed” together along a predetermined line. The seaming may utilize stitching, using an adhesive, stapling, pinning, or any other means that will connect the two parts to each other.

### DETAILED DESCRIPTION

To provide a better understanding of the basic structure of some examples the smoke-guards and door-panels made according to the inventive concepts and principles of the present invention, we refer now to the drawings. It should be noted that the disclosed invention is disposed to versions in various sizes, such as lengths, widths, and depths to accommodate the variety of sizes of doors and door spaces, in addition to a variation in shapes, contents, number and composition of layers, materials, and attachment means. Therefore, the versions described herein are provided with the understanding that the present disclosure is intended as illustrative and is not intended to limit the invention to the versions described.

If there is a fire outside of a closed-door room, it is often recommended to stuff a wet towel into the gap found between the bottom of the door and the floor space to provide at least a temporary safeguard against fire and smoke entering through that space. The many problems with this include, the wet towel must be of the long, wide, and thick enough to span the gap and to fill all of the space. Moreover, in order for a towel to be wet there must be a water source which may be present in many, but not all, hotel rooms and in some dormitory rooms, but is unlikely to be available in rooms in office buildings. And even when water is available, it is very difficult to stuff a wet towel in the space under a door so that the entire space is blocked, and, ultimately, once the towel is in place and there is a fire, it is only a matter of minutes before the heat of the fire dries the towel and the towel ignites. Accordingly, the present invention provides a set of inventive concepts and principles that provides for the manufacture of a device to completely seal the space found between the bottom of doors and the floor. In the following discussion, the present inventor provides several examples of his inventive concept and the inventive principles that will teach the fire and smoke resistant door panel.

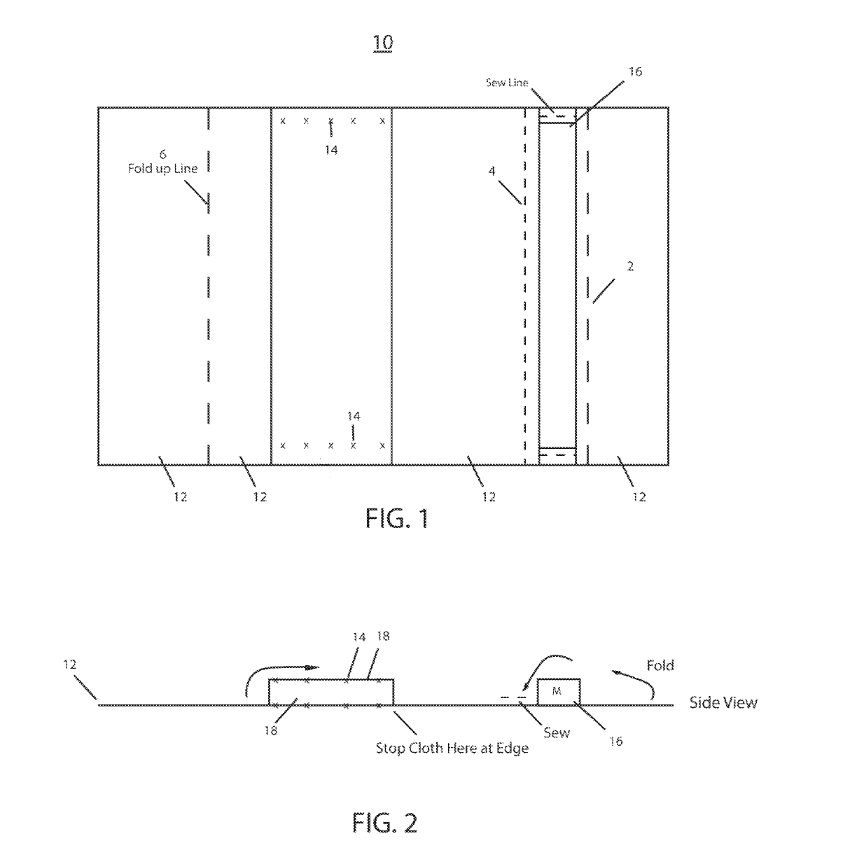

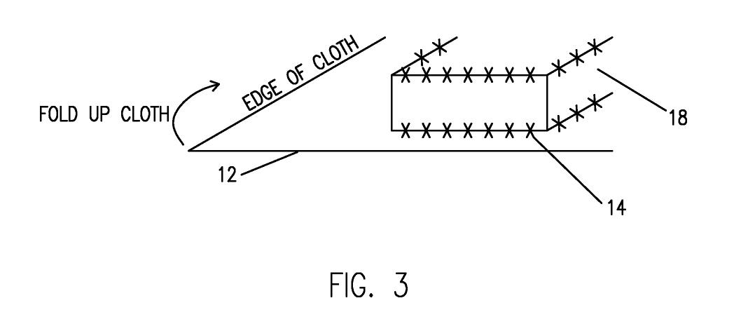

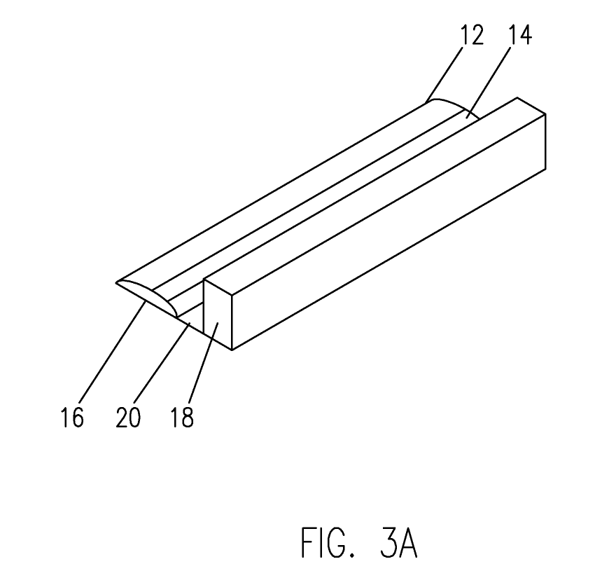

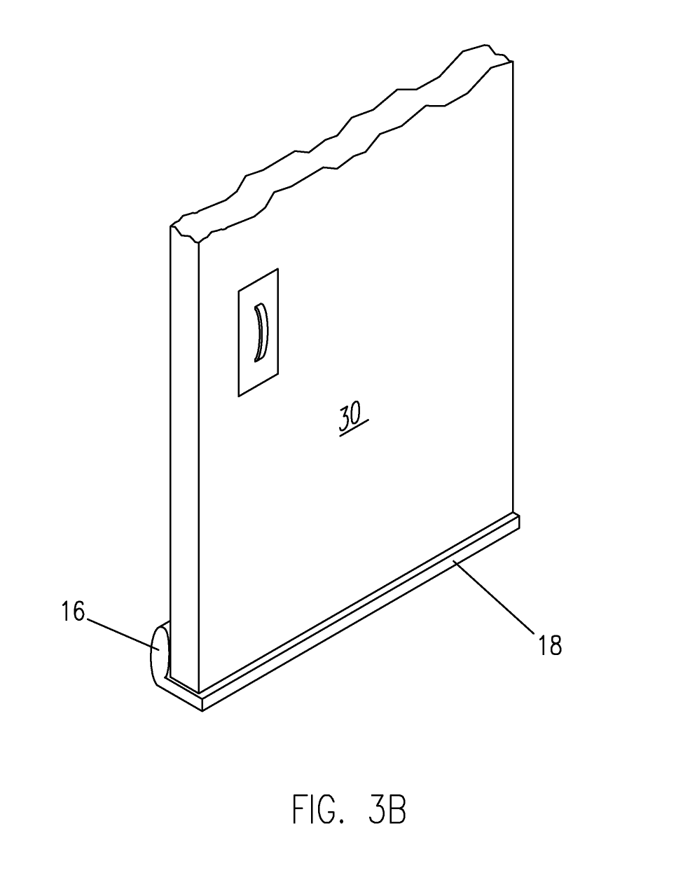

FIG. 1, a plan view, and FIG. 2, a side view, illustrate one example of the basic construction of a smoke-guard device following the principles of the present invention. Modern building codes mandate that there be a space between the bottom of a closed door and the floor. In the event of a fire smoke, lethal gases, and fire can easily pass into a room through this space. Smoke-guard device 10 has been devised to completely block that space and to completely prevent smoke, lethal gases, and fire from getting into a room through this space. The construction of device 10 starts with a length of high temperature cloth 12 cut to the width of the door with which the device is to be used. High-temperature cloth 12 is impermeable to smoke, gases, and if desired, to moisture, as well, and is either treated with a tested and rated fire-retardant or is manufactured from a tested and rated material that is non-flammable and is available in all required door-way widths and lengths. At a given distance from a first end of the length of the cloth an area having the width of the cloth is set aside for receiving a piece of compressible/re-expandable material 18, which in this example is a type of memory-foam, preferably fire-retardant. It is to be understood that the inventive concepts allow for any type of material that will both compress and re-expand. Although the foam strip may be adhered to the cloth using several different methods, the example provided uses an adhesive. As illustrated by FIG. 1, on each edge of the defined cloth area that is to receive foam 18, one side of a strip of two-sided adhesive tape 14 is adhered to the cloth. The other side of the two-sided adhesive tape 14 is to receive and adhere to a first surface of the piece of compressible/re-expandable foam 18, as illustrated on FIG. 2. Once the strip of foam material 18 has been adhered to tape 14, second strips of two-sided adhesive tape 14 are positioned onto edge areas of the second (upper) surface of the strip of foam material 18. The first end of the length of high-temperature cloth 12 is then lifted up and folded, as indicated by the fold-up arrow illustrated in FIG. 2, along fold line 6 (as illustrated on FIG. 1), over foam material 18 so that the first end of cloth 12 completely covers the top and side edges of foam block 18, as illustrated on FIG. 3. The folded-over section of the cover, in this example, is adhered to the side surface of block 18 using two sided adhesive tape 14 that was positioned on the side surface of the foam block 18, as is illustrated in the perspective diagrammatic sketch shown in FIG. 3. At a determined distance from the second end of the length of cloth 12, as illustrated in FIG. 1, magnetic material, such as the strip of magnetic material 16 that is used as an example in this illustration, is positioned across the width of cloth 12, as shown. Magnetic strip 16 is positioned at a distance from the second end of the length of cloth 12 to provide a sufficient length of cloth to fold up along fold line 2 and over magnetic strip 16 leaving a sufficient amount of cloth on each of the raw edges of the cloth to come into contact with each other after the second end is folded over the magnetic strip, as illustrated by the fold arrows in FIG. 2, so that these edges may be securely stitched closed along sew lines 4 as illustrated in FIG. 1. It is to be understood that the method of attaching the metal to the cloth is by way of example and that other methods, known or yet to be know, may be used. The method used will depend on part on the magnetic material used. Alternatively, the cloth itself, or parts of the cloth, may be impregnated with a magnetic material or be a magnetic material. In this example, magnetic strip 16 happens to be about one inch thick, but it is to be understood that the thickness is determined by the properties of the materials being used, such as the magnetic property of a metal door and the corresponding magnetic property of the magnetic strip. This method, of course, is for use with a metal door or a door that has been adapted for magnetic attachment. The smoke-guard is now ready for use. The type of foam used may be memory foam, although it is to be understood that the compressible/re-expandable material can be any material that re-expands when compressed. The compressible/re-expandable material, ideally, is impermeable to smoke, gases, and, if desired, to moisture and is either treated with a fire-retardant or is fire resistant or non-flammable. In this illustration, the foam that is used simply for illustration is a compressible/re-expandable material of about 1½ inches thick. The thickness of the foam, of course, is determined by the height of the gap between the bottom of the door and the floor that must be blocked and the width of the compressible/re-expandable material used is determined by the width of the doorway.

As indicated in FIG. 3a, intumescent material 20 may be added to cloth 12 in the area of cloth 12 between magnetic strip 16 and compressible/re-expandable material 18. Intumescent material 20 adds an additional level of protection against smoke or fire entering a room. Intumescent materials swell upon exposure to a certain degree of heat to assure that the smoke-guard remains in place to securely prevent any ingress of smoke, gas, or fire. Additionally, intumescents are highly endothermic and contain a lot of chemically bound water, such as in the form of hydrates, and as this water is heated and released, it acts to cool adjacent materials, thus prolonging the time of protection.

As illustrated in FIG. 3b, to use the smoke-guard, compressible/re-expandable material 18 end is compressed and inserted into the space under the door from the inside of the closed room. Once the space is completely filled by the foam containing end of the smoke-guard, the compressible/re-expandable foam will re-expand to completely and securely fill all of the door-gap space. Again, from the inside of the room, magnetic strip 16 end of the smoke-guard is then lifted up off of the floor and magnetically adhered to the door

If desired, the smoke-guard device can be made without the intumescent and without the magnetic strip. If made without magnetic strip 16, an adhesive could be used to fasten the end of the strip to the door, although it should be noted that the use of magnetic strip 16 is a secondary precaution. The device will work as desired without this added measure. The protection offered by cloth 12 in conjunction with compressible/re-expandable material 19 is significant.

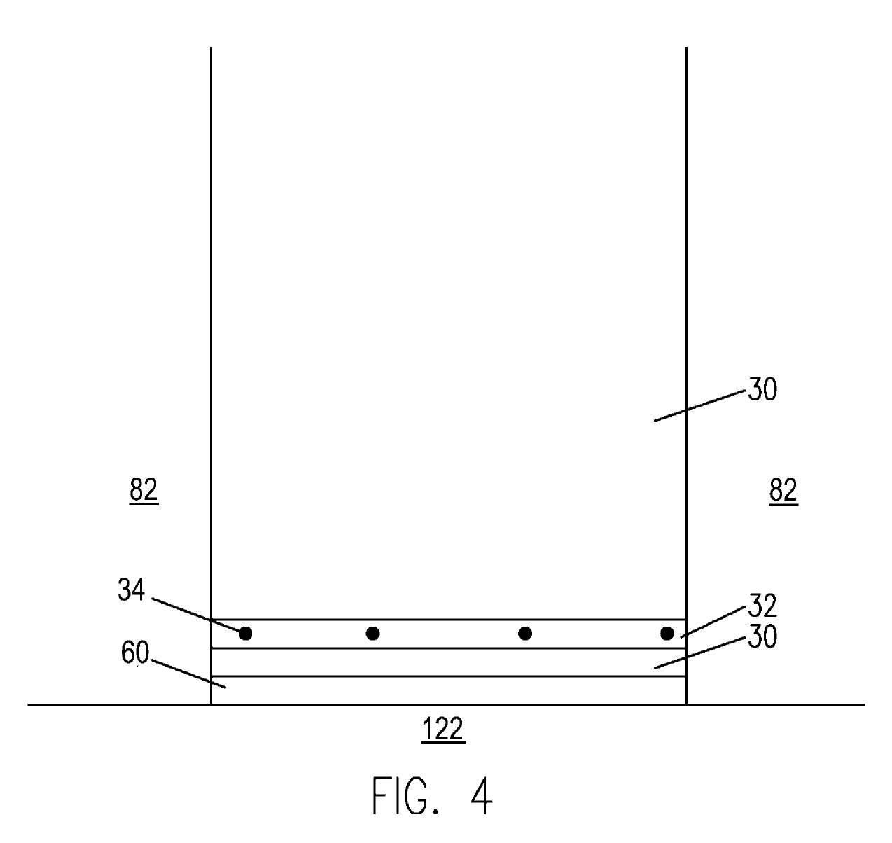

If the door is wooden, instead of metal, the smoke-guard is available with a flat magnetic strip for attachment to the wooden door to provide for the smoke-guard device to be used to block the mandated gap 60 between the bottom of a wooden door and floor 122, in an analogous fashion to the way the device is used with a magnet for extra secure attachment to the door. FIG. 4, an elevation view of installed wooden door 30, illustrates how magnetic strip 32 may be attached to wooden door 30. In the example illustrated, magnetic strip 32 is attached to wooden door 30 using attachments 34 such as screws that are installed into screw holes 34 that are pre-drilled through strip 32. It is to be understood that the method of attachment of magnetic strip 32 to door 30 can be any method of attachment, such as double-sided tape pre-applied to the device ready to be used to tape the device to the door or adhesive, for example. Any others attachment means that work to attach the magnetic strip to the door so that it can be used as intended are within the principles of the present invention. As with the metal door, the smoke-guard for the wooden door may be made and used without the additional safeguards of attaching the device to the door using magnetic devices or adhesive, for example, and with or without the use of intumescent. However, each of these added features provides extra protection and, thus, maybe extra time against the entry of smoke or flames during a fire event.

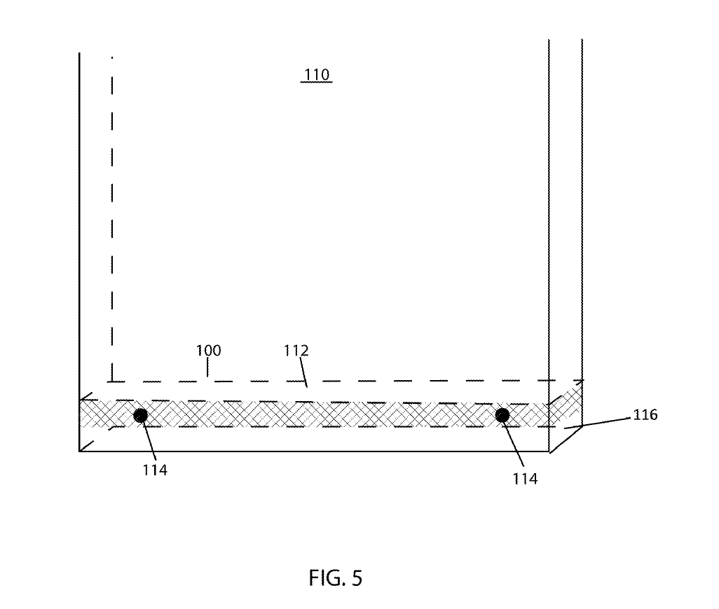

Another embodiment of the smoke-guard made according to the principles of the present invention is illustrated in FIG. 5. This “stored-in-door” embodiment is especially useful for new builds or for when doors are being replaced. A metal door is used in this illustration, although the door could be of wood, plastic, or any other material of which doors are made. In this example, at least the bottom-most section of the interior of the door is hollow 116. Smoke-guard 10, made according to the principles of the present invention, is installed within the hollow space at the bottom of the door during, or after, the manufacture of the door. The door is fashioned with two apertures through which handles, levers, or control buttons 114 are positioned. for There are many ways to cause smoke-guard 10 to be moved-down to the floor providing for smoke-guard 10 to fully fill the space between the bottom of the door and the floor to prevent any smoke, lethal gas, or fire from entering the room. For example, releasing fixtures 114 are connected to the smoke-guard just under support plate 112 of smoke-guard 10 so as to support the smoke-guard in the shown position within the hollow space in the door. By pulling out the rod-like supports controlled by releasing fixtures 114, the support for the smoke-guard is removed causing gravity to pull the smoke-guard to the floor. Alternatively, each releasing fixture 114 comprises a knob on the outside of the door, as illustrated in FIG. 5, with a rod, or the like fixed to and extending from the knob through a portion of the smoke-guard providing support for the smoke guard. Sliding the knob through a slot that is provided in the front most section of the door (not shown) causes the rod to move from its position near support plate 112 down toward the floor resulting in moving smoke-guard 10 down to the floor. In both of these cases, the compressible/re-expandable smoke-guard material is automatically placed into position to completely fill the gap between the bottom of the door and the floor. The two examples provided are exemplary only. There are many ways that the smoke-guard can be supported and released and as these are well-known in the art, there no further discussion will be provided. Smoke-guard 10 is available with or without the magnetic strip and/or an application of intumescent.

Except for the “stored-in-door” model, smoke-guard devices are available in their own container designed to hold the device until needed. So that the device is available when needed, the smoke-guard kit is designed to be hung, or otherwise attached, to a wall or the back of a door. Smoke-guards are also available in plastic-type bags, to be carried in a suit case for travelers to carry them when staying in buildings that may not have such a safeguard.

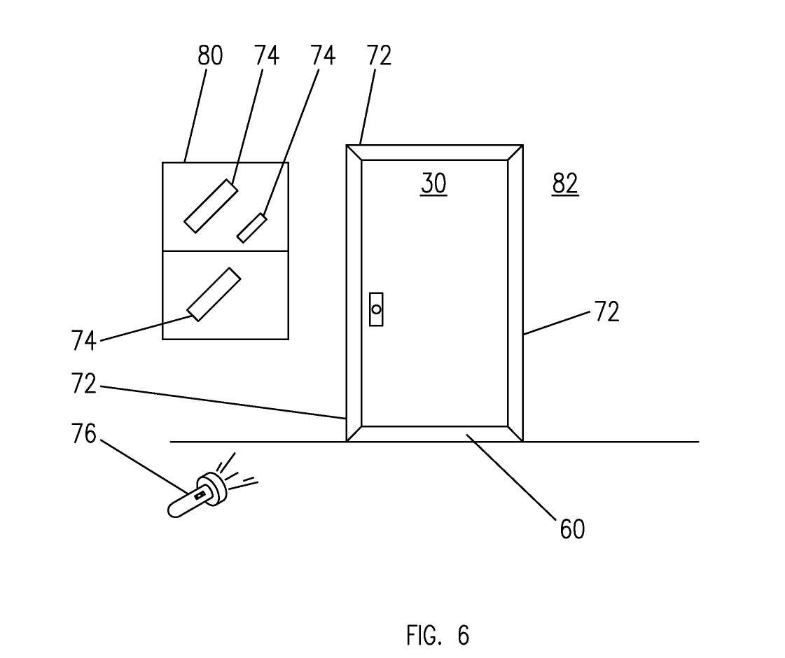

Some doors do not fit tightly in the confines of the door jam. In the event there are openings between the door jamb and the side and top edges of the door, the smoke-guard kit includes self-adhering tape 72 that are available as fire-resistant and/or intumescent strips for placement over such openings. Illustrated in FIG. 6, is tape 72 positioned over the door top and side opening adhering to both door 30 and wall 82. When exposed to heat, intumescent strips expand to create an enhanced smoke barrier and also, as discussed above, upon expansion, the intumescent material releases water that reduces the temperature of the door. This is important in that most doors used in public buildings are only fire-rated to last from 20 minutes to 1½ hours in a fire. The smoke-guard is rated for two or more hours, depending on the materials used in manufacture.

Many homes and apartments, hotels and hospitals are not in compliance with the requirements of the fire code. For example, hotels and tourist spots are infamous for not following the fire code requirements and for not maintaining their fire protection equipment properly. Shockingly, there are many college dormitories that are not equipped with ceiling sprinkler systems. In such cases, having access to a smoke-guard of the present invention is especially important, and even more so in rooms from which there is no easy or safe egress. It is well-accepted that windows should not be opened in a fire because of the fire-drawing draft that an open window would create. Closed windows, however, may give one the feeling that no one knows that they are in the room and need to be rescued. To alleviate this concern, the smoke-guard is available with strips of fluorescent tape 74, or the like, to be placed on a window 80 to provide notice to emergency personnel. Also available is flashlight 76 for use if it is dark and the lights go out and to alert emergency personnel to the situation. Alternatively, there is available a glow-light (also known as a glow-stick) that is rated to last for 12 hours and requires no batteries.

Thus, it has been shown that the present invention includes a smoke-guard, a smoke, gas, and fire barrier device for under-door gaps. A basic smoke-guard comprises a unit of expandable/compressible material fully covered by a length of fire-resistant and smoke and gas impermeable material and sized to completely seal the mandated gap between the bottom of doors and floors in the event of a fire. Another style includes magnetic material adhered to an extending end of the length of fire-resistant, moisture and gas impermeable material to further adhere the barrier to a metal door. Intumescent material may be fixed on the central part of the length of fire-resistant, moisture and gas impermeable material. The device is sized to fit commercial and private doors spaces and is offered in a kit including tape to place about top and sides openings of a door, luminescent tape to be placed on a window in the room, and a flashlight and/or glow-stick of various styles. The fire-resistant material may also be water impermeable.

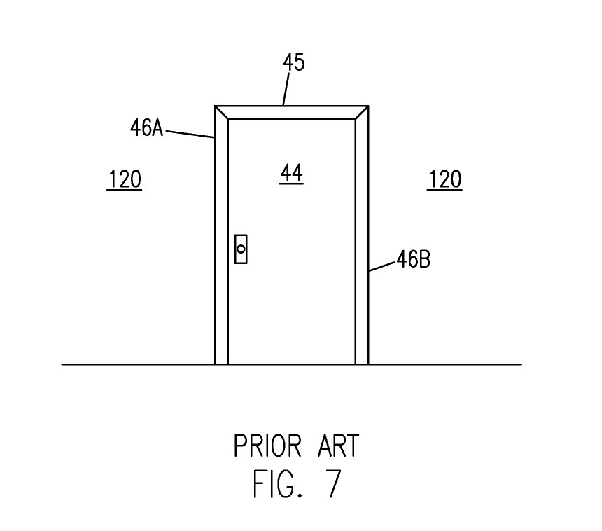

Preventing smoke, lethal gases, and fire from entering a room from gaps found about a door addresses only part of the problem faced by anyone trapped in a closed room while during a fire outside the room. As mentioned above, most doors used in public buildings are only fire resistant rated from 20 minutes to 1½ hours. If the room is equipped with a smoke-guard that is rated for two or more hours and if the smoke-guard is correctly positioned its protection is limited by the time that the door will resist the fire. FIG. 7 illustrates a standard wooden door 44 and a door frame of top section 45, and left and right sections 46a and 46b, respectively installed into a wall constructed of dry wall 120. Dry wall is quite resistant to fire. When used as a component in fire barriers, drywall is rated as a passive fire protection item. Drywall is constructed using the mineral gypsum. In its natural state, gypsum contains water of crystallization bound in the form of hydrates that will vaporize when exposed to heat or fire. The water of vaporization retards heat transfer. Therefore, a fire in one room that is separated from an adjacent room by a fire-resistance rated drywall assembly will not cause this adjacent room to get any warmer than the boiling point (100° C.) until the water in the gypsum is gone. Evidence of this can be found both in publicly available design catalogues, including DIN4102 Part 4 and the Canadian Building Code on the topic, as well as common certification listings, including certification listings provided by Underwriters Laboratories and Underwriters Laboratories of Canada (ULC). “Type X” drywall is formulated by adding glass fibers to the gypsum, to increase the resistance to fires, especially once the hydrates are spent, which leaves the gypsum in powder form. Type X is typically the material chosen to construct walls and ceilings that are required to have a fire-resistance rating. Doors, however, can be much less safe. In a house fire, hollow and six-panel doors are notorious for burning through in about 20 minutes. Thus, it is clear that the weak-link is the non-fire door, usually wooden.

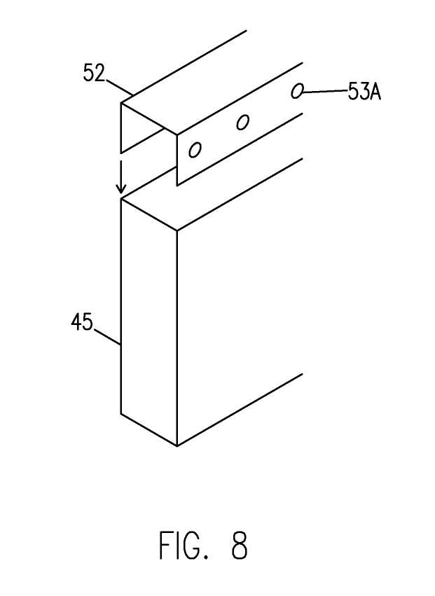

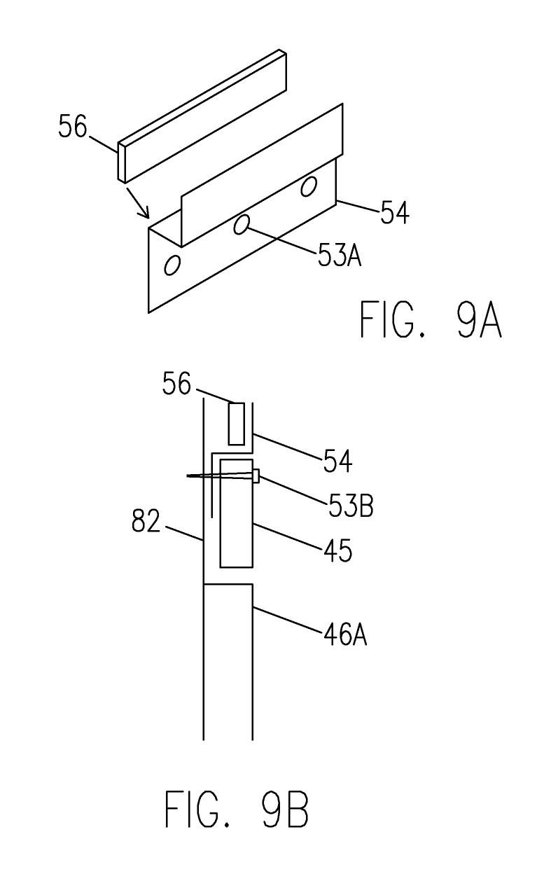

The present inventive concept includes a fire-tested and rated material panel door-covering that will stop a fire from entering a room for at least two hours even if the door, itself, burns down completely. The material panel is easy to use, when needed in the event of a fire, as long as the required metal bracket, as explained above, is secured to the top-piece of the door frame in advance. This metal bracket, with or without an accessory magnetic piece, as explained above, is used to support the panel. FIGS. 8 and 9B illustrate examples of such metal brackets 52, 54 shaped and sized to be easily installed over the top-piece of door frame 45. Once metal bracket 52 is situated over the top-piece 45 of the door frame, connecting apertures 53A are used with known attachment means, such as screws, for example, to secure the bracket and the frame to the wall (see, for example FIG. 9B). FIG. 9a illustrates another example of a door frame bracket sized and shaped to be easily and quickly installed over the top-piece of a door frame. In this case, bracket 54 is installed by loosening or partially removing top door frame piece 45, providing for the downturned vertical part of the bracket to be placed behind the top-piece of the door frame and the horizontal part of the bracket with its extending upturned vertical part to be placed over the top surface of the top-piece of the door frame, as illustrated in FIG. 9B. When using bracket 54, once the bracket is in position, it, along with the top-piece of the door frame, is secured to the dry-wall by inserting attachment means 53b into apertures 53a. It is to be understood that in addition to the two examples of brackets just described, any other attachment means that will achieve the desired connection between a bracket and the door is contemplated by the invention. Thus, even if the door and door frame burn, the bracket is secured to the dry wall that has a far greater fire-resistance than the door. Note that all styles of bracket are metal and may include magnetization. In the example illustrated, additional magnetization is provided by magnetic strip 56 that is positioned between the bracket 54 and the wall, as illustrated in FIG. 9B. The magnetization, however, could be part of the bracket itself or any other type of device that will provide magnetization to the bracket of choice.

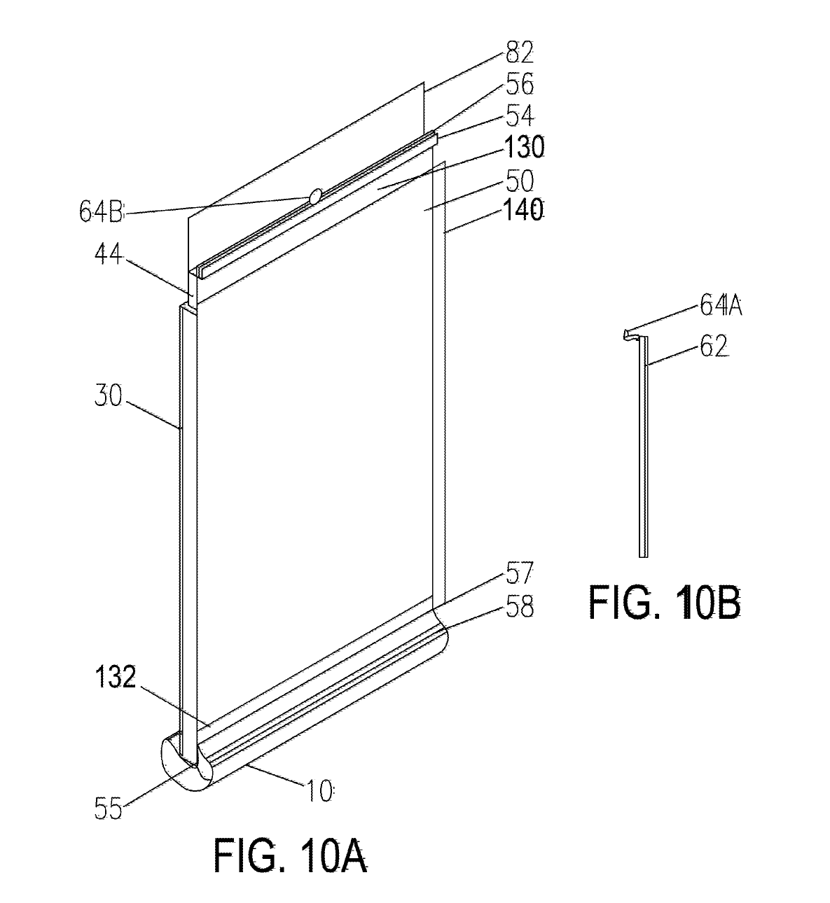

FIG. 10A, a perspective diagrammatic sketch, illustrates door panel 50, an exemplary embodiment of the present invention, as it is being installed. Door panel 50 is a fire-tested and -rated material that can stop smoke, lethal gases, and fire from passing through a doorway when installed over the doorway as will be described. For the best protection available from smoke, lethal gases, and fire, door panel 50 should be used in combination with the smoke-guard device, as described above. To install door panel 50 over door 30, one need only hold panel 50 up against door 30 so that magnetized top end 130 of panel 50 becomes magnetically secured to magnetic bracket 54. In the example shown, the magnetism of bracket 54 is enhanced by the addition of magnetic bar 56. Once the panel is in place, fire-resistant tape 140, which may also be intumescent fire-resistant tape, seals the sides of the panel to the wall, and to the floor in the case that a smoke-guard device is not being used, to providing a secure fire-tested and rated barrier to smoke and fire, even if the door, should it be a wooden door, burns. If the tape is intumescent, in addition to being fire resistant, the intumescent material will swell to provide additional protection from fire or heat reaching top section 44 of the door frame. If the top-piece of the door frame is too high for a person to reach, or the person trapped is too short, the panel kit includes pole 62, as shown in FIG. 10B. Pole 62 is length extendable and has hook 64a on one end to enable a person to lift panel 50 high enough so that the magnetized end 130 of panel 50 will become secured to metal bracket 54. To use pole 62, hook 64a is engaged with hook receptacle 64b on the top section of panel 50, as shown in FIG. 10A, so that panel 50 is easily lifted into place with the assistance of pole 62. Bottom edge 132 of panel 50 is also magnetized to take advantage of the magnet that is included with the smoke-guard. It should be understood that either the top end or the bottom end of panel 50 may be made of magnetic material or have a magnetic bar stored within a pocket either at the top or bottom or both of panel 50. Although panel 50 may be used without a smoke-guard, it cannot be urged strongly enough to do so. Smoke with its accompanying lethal gases cause most fire-related deaths. Each year, thousands of people lose their lives due to smoke inhalation and several thousand more suffer permanent respiratory damage or suffer long term smoke related injuries. Most fire deaths are the result of smoke inhalation, not burns, because without oxygen and the inhalation of the toxic fumes, we can survive only three minutes. In minutes, a fire can spread, consuming oxygen and quickly filing rooms and corridors with black smoke that blocks oxygen to the brain, sears mouth, throat and lungs and makes individuals drowsy, short of breath, disoriented and incapacitates so quickly that people are overcome before they can escape. It has been reported that smoke containing carbon monoxide can cause brain damage in 10 minutes and kill you in less than 20 minutes. Thus, it is clear that in the event of a fire, the first thing anyone should do when trapped in a closed room, is to use the smoke-guard device 10 first to protect the room occupants from smoke and lethal gas. As soon as the room is secured from the entry of smoke and gas, the fire-retardant and smoke-proof door barrier panel 50 should be installed.

In the example used for illustration, cloth panel 50 is manufactured from Z-Block filament fiberglass material rated to 1500° F. Z-Block Products are available from Newtex Industries, Inc. of Victor, N.Y. It should be understood that the fire retardant panel does not rely solely on Z-Block products and that there are other known, and as yet, unknown, materials that are fire retardant and all are considered to be within the scope of the inventive concept and it attendant principles.

Thus, it can be seen from the above discussion that Applicant is teaching his inventive concept and all of its inventive principles to provide for fire and smoke-guard devices to keep smoke and flame from entering a room. The inventive principles include the use of intumescent tape to seal the non-air tight spaces at the sides and top of a door, as well as aids such as reflective tape and a battery to provide notice to those outside the building that a person is trapped in the room. Moreover, as the smoke-guards, fire-retardant panels, and their accessories may be constructed of presently available and permitted materials, the cost to manufacture is minimal, thus making these essential safety features, agreeably affordable.

It has been shown that the combined use of the tested and rated smoke-guard device and the tested and rated fire and smoke retardant panel, as taught, prevents fire, smoke, and lethal gases from entering a room through a doorway providing two or more hours for a person(s) trapped by a fire in a closed room to be rescued, even if in a room that has a residential style wood door that is known to burn in about 20 minutes.

The foregoing description, for purposes of explanation, used specific and defined nomenclature to provide a thorough understanding of the invention. However, it will be apparent to one skilled in the art that the specific details are not required in order to practice the invention. The disclosed descriptions and illustrations are not intended to be exhaustive or to limit the invention to the precise forms disclosed. Those skilled in the art will recognize that many changes may be made to the features, embodiments, and methods of making the versions of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A fire-stopping opening-cover, comprising:
a fire-rated cloth panel sized and shaped to cover a specifically sized opening with borders about the opening, and
fire-rated tape;
said panel once positioned against and secured to the borders of the opening by said fire-rated tape will prevent fire, smoke, and lethal gases from passing through the opening for up to two hours.

2. The fire-stopping opening-cover, as recited in claim 1, wherein said panel and said opening each having at least one border having magnetic properties, said magnetic panel border to be secured to said magnetic opening border.

3. The fire-stopping opening-cover, as recited in claim 2, further including where said opening is a doorway in a wall fitted with a metal doorframe and a metal door having magnetic properties.

4. The fire-stopping opening-cover, as recited in claim 2, further including where said opening is a doorway in a wall fitted with a wooden doorframe and a wooden door.

5. The fire-stopping opening-cover, as recited in claim 4, further including a metal bracket with magnetic properties for securing over a top-piece of a wooden or a metal door frame, said metal bracket positioned so as to provide a magnetic border for said doorway opening.

6. The fire-stopping opening-cover, as recited in claim 2, wherein a first end of said panel has magnetic properties.

7. The fire-stopping opening-cover, as recited in claim 6, wherein a piece of magnetic metal enclosed within said first end of said panel is the source of said magnetic properties.

8. The fire-stopping opening-cover, as recited in claim 5, further including a magnetic strip positioned between the top-piece of the door frame and the wall so as to be a source of extra strong magnetic properties.

9. The fire-stopping opening-cover, as recited in claim 4, wherein a second end of said panel has magnetic properties.

10. The fire-stopping opening-cover, as recited in claim 9, wherein a piece of magnetic metal enclosed within said second end of said panel is the source of said magnetic properties.

11. The fire-stopping opening-cover, as recited in claim 10, further including a smoke-guard device, comprising compressible/expandable material covered by a first end of fire-rated cloth sized for insertion into a gap between the bottom of a closed door and a floor to prevent any smoke from traversing the gap before securing said panel to the border openings.

12. The fire-stopping opening-cover, as recited in claim 8, wherein a second end of said fire-rated cloth is magnetized to secure said smoke-guard device to a magnetic portion of the door.

13. The fire-stopping opening-cover, as recited in claim 9, wherein a metal bar secured in said second end of said fire-rated cloth is the source of the magnetization.

14. The fire-stopping opening-cover, as recited in claim 7, wherein a piece of metal is secured to the door, when the door is a wooden door, said metal providing a magnetic portion to the door.

15. A smoke, lethal gas, and fire stopping combination for a doorway fitted with a magnetic metal door and magnetic metal door frame, comprising:
a smoke-guard device comprising:
a fire-resistant cloth having:
a first end secured about a compressible/expandable material sized to be inserted into a space between the bottom of a door and a floor, and
a second end magnetized to be secured to the door,
fire-resistant intumescent-coated tape, said tape sized to cover gaps between a doorframe in a wall and the sides and top of the door,
said first and second end of said device once inserted and secured, respectively, will prevent fire, heat, smoke, and gas from passing through the doorway for two or more hours as long as the door does not burn, and
a fire-rated cloth panel sized and shaped to cover the door,
said panel having a magnetized first end and a magnetized second end,
said magnetized first end to be magnetically secured to a top-piece of the doorframe,
said magnetized second end to be magnetically secured to said second end of said magnetized cloth of said smoke-guard device once the smoke-guard device is inserted and secured, and
fire-resistant intumescent tape sized so as to seal the sides of the panel to the wall so as to secure the doorway against the passage of smoke, lethal gas, and fire for up to two hours even if the door burns.

16. A smoke, lethal gas, and fire stopping combination for a doorway fitted with a wooden door, comprising:
a smoke-guard device comprising:
a fire-resistant cloth having:
a first end secured about a compressible/expandable material sized to be inserted into a space between the bottom of a door and a floor, and
a second magnetic end to be secured to a magnetized portion of the door, and
fire-resistant intumescent-coated tape, said tape sized to be cover gaps between a doorframe in a wall and the sides and top of the door so as to prevent fire, heat, smoke, and gas from passing through the doorway for two or more hours as long as the door does not burn, and
a fire-rated cloth panel sized and shaped to shield the door having a magnetized top-piece of the doorframe,
said panel having a first end magnetized and a second end magnetized,
said first end to be magnetically secured to the magnetized top-piece,
said second end to be magnetically secured to said second magnetic end of said smoke-guard once said smoke-guard is inserted into the space between the bottom of the door and the floor, and
fire-resistant intumescent tape sized so as to seal the sides of the panel to the wall so as to secure the doorway against the passage of smoke, lethal gas, and fire through the doorway for up to two hours even if the door burns.

17. The smoke, lethal gas, and fire stopping combination, as recited in claim 17, further including a strip of fire-rated tape so as to further adhere the second end of the smoke-guard to the door.

18. The smoke, lethal gas, and fire stopping combination, as recited in claim 16, further including a magnetic metal bracket for securing over the top section of the door frame.

19. The smoke, lethal gas, and fire stopping combination, as recited in claim 18, further including a magnetic strip positioned between the metal bracket and the wall.

20. The smoke, lethal gas, and fire stopping combination, as recited in claim 17, further including a magnetic strip sized to be affixed to the door, said strip securing said second end of said smoke-guard to the door.
